(19) United States
(12) Patent Application Publication
(10) Pub. No.: US 2022/0405726 A1
(43) Pub. Date: Dec. 22, 2022

(54) ELECTRONIC FINANCIAL TRANSACTION SYSTEM AND METHOD

(71) Applicant: AppSar Pty Ltd, Brisbane (AU)

(72) Inventors: Andrew Garland, Brisbane (AU); Rob Welch, Brisbane (AU); Simon Hewitt, Brisbane (AU); Tycho Luyben, Brisbane (AU)

(21) Appl. No.: 17/624,213

(22) PCT Filed: Jul. 2, 2020
(86) PCT No.: PCT/AU2020/050686

§ 371 Date: Dec. 30, 2021

(30) Foreign Application Priority Data
Jul. 2, 2019 (AU) 2019902345

(51) Int. Cl. G06Q 20/10; G06Q 20/32; G06Q 20/36; G06Q 20/40

(52) U.S. Cl. CPC G06Q 20/108; G06Q 20/325; G06Q 20/36; G06Q 20/4014; G06Q 20/4015

(57) ABSTRACT

An electronic fund transfer system comprises a transaction server, a first mobile electronic device operated by a first user, and a second mobile electronic device operated by a second user. The transaction server stores user profiles, including financial account details and other personal details, for each of the first user and the second user, and further stores therein a list of first users associate with a premise. The second mobile electronic device is operable to obtain from the transaction server the list of first users associated with the premise. The second mobile electronic device is further operable by the second user to select one first user from the list and effect a transfer of funds from the second user to the selected first user. The transfer of funds from the second user to the selected first user is effected without any of the financial account details and other personal details of the first user being provided to the second user.

### FIELD OF INVENTION

The present invention relates to systems and methods for effecting electronic financial transactions. The present invention has particular but not exclusive application in electronic financial transactions that seek to minimize the amount of information required to effect such financial transactions.

### BACKGROUND OF THE INVENTION

The transfer of monies/funds from one person to another has typically required the recipient of such monies/funds to provide to the sender of such monies/funds information such as the recipient's name, bank, bank account details, address, email address, and phone number. Such information is often considered personal/private, and subject to being used for malicious purposes such as identity theft, unsolicited correspondences, and the like.

It would be advantageous if monies/funds could be transferred from a sender of such monies/funds to a recipient of such monies/funds without the recipient needing to divulge to the sender such information. It would further be advantageous if monies/funds could be transferred from a sender to a recipient without the sender needing to make known to the recipient that such a transfer is being made.

### OBJECT OF THE INVENTION

It is one object of the present invention to provide a method and/or system that facilitates the sending of monies/funds from a second user (a sender) to a first user (a recipient) without the need for the first user to divulge to the second user any personal information, or to at least significantly minimize the need for such information.

It is a further object of the present invention to provide a method and/or system that facilitates the sending of monies/funds from a second user to a first user without the second user needing to make known to the first user (whether explicitly, or implicitly by, for example, having to request information from the first user) that such a transfer was made.

These and other objects of the present invention will be made apparent from the following disclosure of the invention.

### SUMMARY OF THE INVENTION

According to a first aspect of the present invention, an electronic fund transfer system including

a first device operated by one or more first users;

a second device operated by at least one second user, and

a sever to store user profiles of the one or more first users and the at least one second user, said profiles include account details and personal details of the one or more first users and the at least one second user;

wherein the one or more first users are associated with a premise, and wherein the server further stores the associated information between the one or more first users and the premise;

wherein in use, the second device is operable to obtain the associated information between the one or more first users and the premise, and a fund can be transferred by the at least one second user to the one or more first users without providing any of the account details or personal details of the one or more first users to the at least one second user.

Preferably the associated information includes a list of the one or more first users associated with the premise, and whether the one or more first users is a verified user associated with a verified premise.

Preferably the second device can be operated to select a first user from the list to transfer the fund.

Preferably the premise is defined by a boundary of the premise. Preferably the boundary of the premise is defined by physical perimeter, GPS coordinates, wireless access points, and/or Bluetooth connection.

In one embodiment, the premise is a fixed venue, including a restaurant, bar, club, shop, office, hall or stadium. Preferably the boundary of the fixed venue is defined by a physical perimeter of the fixed venue.

In another embodiment, the premise is a mobile venue, including a bus, car, taxi, ship/boat/ferry, train, plane, or food/drinks cart. Preferably the boundary of the mobile venue is defined by a certain radius around the location of the mobile venue by using GPS coordinates, wireless and/or Bluetooth communication.

In a further embodiment, the premise is a user specified boundary, including a delimited area in a park or a street corner. Preferably the user specified boundary is defined by a certain radius around the location of the premise by using GPS coordinates, wireless and/or Bluetooth communication.

Preferably a first user of the one or more first users is a verified user when verified by a premise controller, said premise controller is a person who controls who may or may not be associated with the verified premise.

In one embodiment, the fund is selected from a merchant transaction from the at least one second user to the premise or the one or more first users. In another embodiment, the fund is selected from a voluntary transaction from the at least one second user to the premise or the one or more first users.

Preferably the one or more first users include a waiter, bartender, dancer, cook/chef, musician, busker, or shop/stall owner.

Preferably the at least one second user is a person receiving or received a service at the premise, or a person having or had one or more interactions with the one or more first users at the premise.

Preferably the server further stores a list of one or more premises and boundaries of the one or more premises.

Preferably the server further stores one or more rules for interactions between the one or more first users and the at least one second user, wherein the one or more rules includes determining whether the interaction occurs within the boundaries of the one or more premises.

Preferably a first user of the one or more first users is a verified user associated with the one or more premises when verified by a premise controller, said premise controller is a person who controls who may or may not be associated with a verified premise; and wherein the verified user is in a form of a list of the one or more first user associated with the one or more premises when the verified user is located within the boundaries of the one or more premises.

Preferably the premise controller is a person who is responsible to set up and/or manage the premise.

Preferably the system further includes a third device operated by the premise controller and the third device interacts with the server to verify the premise and one or more of the first users.

According to a second aspect of the present invention, there is a method for verifying a first user at a verified premise using the system as describe in the first aspect, including the steps of:

determining a verified premise;

proving at least part of the first user's profile to a premise controller;

determining whether the first user is a verified user by the premise controller by using the at least part of the first user's profile; and

storing the first user in a list of users associated with the verified premise if the first user is verified by the premise controller.

According to a third aspect of the present invention, there is an electronic fund transfer method using the system as described in the first aspect, including the steps of:

selecting a premise from a list of one or more premises;

selecting one or more first users from a list of the one or more first users associated with the one or more premises; and

transferring a fund to the selected one or more first users.

Preferably the step of selecting a premise from a list of one or more premises further includes a step of determining a location relative to boundaries of the one or more premises.

Preferably the system further includes a step of determining verification of the one or more first users in a verified premise.

The above aspects, variations, and options are to be understood as comprisable within the invention singly, or in combination with each other.

### BRIEF DESCRIPTION OF THE DRAWINGS

In order that the present invention can be more readily understood, reference will now be made to the accompanying drawings which illustrate preferred embodiments of the invention and wherein:

FIG. 1 illustrates an electronic financial transaction system according to the present invention;

FIG. 2 illustrates an electronic financial transaction operation according to the present invention; and

FIG. 3 illustrates an operation for verifying a user to be able to be seen by a customer.

### DETAILED DESCRIPTION OF PREFERRED EMBODIMENTS

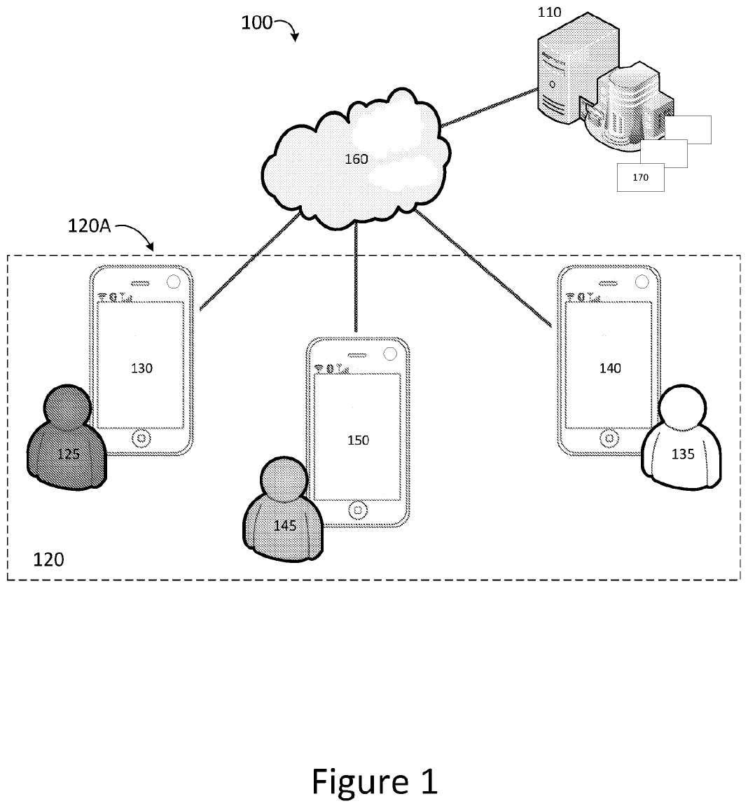

With reference to FIG. 1, an electronic financial transaction (EFT) system 100 according to an embodiment of the present invention is described. The EFT system 100 includes a transaction server 110, at least one premise 120, a first mobile electronic device (hereinafter referred to as a recipient's device) 130 operated by a first user 125, and a second mobile electronic device (hereinafter referred to as a sender's device) 140 operated by a second user 135. The system 100 may further include a third mobile electronic device (hereinafter referred to as a merchant's device or premise controller's device) 150 operated by a premise controller 145. Each of the transaction server 110, first mobile electronic device 130, second mobile electronic device 140, and third mobile electronic device 150 are connected to a network 160.

The first user 125 is a person who is associated with the premise 120. For example, the first user 125 may be a person currently providing a service at the premise 120, a person who has in the past provided a service at the premise, or more generally, a person who has had (or is having) one or more interactions with other persons at the premise 120. Depending on what the premise 120 is, which will be described in greater detail below, examples of such first users 125 include but are not limited to a waiter, a bartender, a dancer, a cook/chef, a musician, a busker (e.g. street performer), a shop/stall owner, and the like. The association of the first user 125 with the premise 120 may be one of a verified worker or an unverified worker as will be described in greater detail below. O

The second user 135 is a person who also has an association with the premise 120. For example, the second user 135 may be a person who is currently receiving a service at the premise 120, a person who has in the past received a service at the premise, or more generally, a person who has had (or is having) one or more interactions with other persons at the premise 120. Depending on what the premise 120 is, examples of such second users 135 include but are not limited to a customer at a restaurant or other business, an audience member (e.g. a person listening to a street performer, or watching a dancer), and the like.

The premise 120 may be a fixed venue, such as a restaurant, bar, club, shop, office, hall (e.g. concert hall, event hall), stadium, and the like. The premise 120 may also be a mobile venue, such as a bus, car, taxi, ship/boat/ferry, train, plane, food/drinks cart, and the like. Further, the premise 120 may also be a user-specified boundary or perimeter that does not necessary correspond specifically to any fixed or mobile venue. For example, the premise 120 may be a user-specified boundary delimiting a certain area in a park, or a street corner,

The premise 120 may be categorized as a verified or unverified premise. A verified premise is one where a first user 125 desiring to be associated with the premise 120 need to first be verified by a premise controller 145 of the premise 120. Conversely, an unverified premise is one where a first user 125 desiring to be associated with the premise 120 may do so without requiring any verification by another party.

The premise 120 is defined by a premise boundary 120A, which serves to establish where a premise 120 starts and ends and who (e.g. first users 125 and second users 135) may be within the premise 120 at any point in time. The premise boundary may be defined by a set of coordinates, for example GPS coordinates. Alternatively, or in addition, the premise boundary 120A may be defined by access to one or more wireless access points provided by the premise such that any electronic device connected to (or in range of) such one or more wireless access points are deemed to be within the premise boundary 120A. Alternatively, or in addition, the premise boundary 120A may be defined as a function of an available signal strength from one or more of such wireless access points. Other means for defining a premise boundary may also be used, such as Bluetooth etc.

In the case of the premise 120 being a fixed venue such as a building or other fixed area (e.g. a restaurant, fair ground, etc.) the premise boundary 120A may correspond to the physical perimeter of such venues. In the case of the premise 120 being a mobile venue (e.g. a boat, taxi, bus, etc.) the premise boundary 120A may correspond to a certain radius around the current location of a given point, for example the current GPS location of the mobile venue. In the case of the premise 120A being a user-specified boundary delimiting a certain area, the premise boundary 120A may be drawn or otherwise indicated on a map by a first user 125 or premise controller 145, or may be a certain radius around the current location of the recipient's device 130 or premise controller's device 150.

As described above, the premise controller 145 is a person responsible for controlling who may or may not be associated with a verified premise. More generally, however, the premise controller 145 is responsible for the setup and/or management of a premise 120, whether fixed, mobile, or user-specified, and whether verified or unverified. For example, the premise controller 145 may be an owner or manager of the premise 120, a coordinator/organizer of an event taking place in/at the premise 120, or a street performer performing independently on a street corner. In the case of the premise controller 145 being, for example, a street performer performing independently on a street corner (or other situation whether the person providing a service is also the person responsible for managing the premise 120 they are providing the service within), it should be noted that the premise controller 145 and first user 125 are in this case the same person, and the recipient's device 130 and premise controller's device 150 may be the same device.

The recipient's device 130 and sender's device 140 are preferably mobile electronic devices, such as smart phones, tablets, laptops and the like, running an app configured to connect said devices with the transaction server 110 and to present to the first user 125 and second user 135 an appropriate interface for interacting with the transaction server 110 and the system 100 in general. The premise controller's device 150 is also preferably a mobile electronic device, but may alternatively be a non-portable electronic device. The premise controller's device 150 similarly runs an app configured to connect said device with the transaction server 110 and to present to the premise controller 145 an appropriate interface for interacting with the transaction server 110 and the system 100 in general.

The transaction server 110 is a network connected server (e.g. a computer) for coordinating and effecting financial transactions conducted via the system 100. The transaction server 110 stores therein a list of premises 120 and their associated premise boundaries 120A. Also stored by the transaction server 110 is a wallet account (or user profile) for each user of the system 100, for example each first user 125 and second user 135. The wallet account for a user (for example, a first user 125 or a second user 135) contains, but is not limited to, all necessary details for accessing (e.g. depositing or withdrawing) funds belonging to the user. For example, the wallet account may store one or more details such as:
Name
Address
Contact details
Credit card details
Bank account details
Paypal™ details
Bitcoin wallet detail
   and the like. The transaction server 110 is preferably a server that is compliant with regulatory standards for payment gateways, such as PCI-DSS, GDPR, and PSD2. The wallet account may further store other optional information, such as a public profile picture, name or nickname, status message, “check in” location, identifying indicia, and the like.

The above described details are private, and known only to the user who provided this information, and as necessary the transaction server 110, unless made accessible by the user to others. That is, information provided by one user (unless deliberately made public or otherwise accessible to others by the user) is not available to any other user, though it may be made available to the transaction server 110 as necessary.

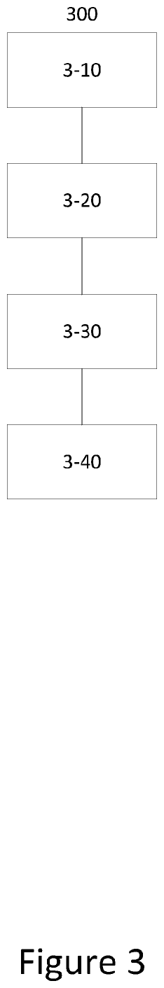

Further stored in the transaction server 110 for each premise 120 is a list of first users 125 associated with each premise 120. If a premise 120 is a verified premise, first users 125 will first need to be verified by the premise controller 145 of that premise 120 before being able to be listed in the transaction server 110 as associated with that premise 120. Any first user 125 may be associated with an unverified premise 120. An operation for verifying a user 125 as a verified user (employee) at a verified premise 120 is described in greater detail below with reference to FIG. 3. For the purposes of this description, the term “employee” as used in the context of an employee of, or at, a verified premise is used to describe a person that works at the premise 120.

Still further stored in the transaction server 110 may be one or more rules 170 (hereinafter referred to as merchant policies or merchant rules) with regard to permitted transactions between first users 125 and second users 135 as set by the premise controller 145 using the premise controller's device 150. Each rule 170 specifies one or more conditions and rules governing interactions and relationships between premises 120, first users 125, and second users 135. Such rules 170 are made applicable within a specified area. For example, each merchant policy may be associated with a premise 120 or a premise boundary 120A, or may otherwise specify its own geographical boundary/limits, within which its conditions and rules apply.

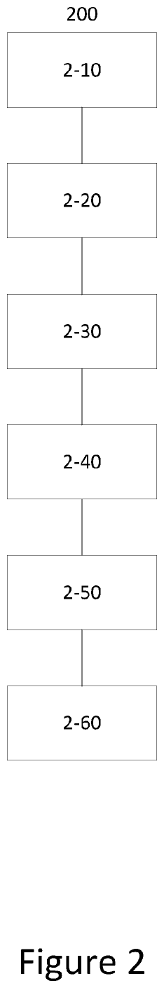

With reference to FIG. 2, an exemplary EFT operation 200 of the EFT system 100 is described. The operation 200 may take place, for example, in a situation where a second user 135 is patronizing, or has patronized, a premise 120 at which a first user 125 is or was working, and the first user 125 has provided one or more services to the second user 135 and the second user 135 is desirous of giving a tip, or otherwise desirous of transferring a sum of money, to the first user 125. The operation 200 may also take place, for example, in a situation where the second user 135 is within a geographical boundary that has been specified by a first user as being a premise 120 (such as a street corner that has been specified by a busker as being the busker's “premise”) and the second user 135 desires to give a tip or otherwise transfer a sum of money to the busker/first user 125.

Both the second user 135 and the first user 125 are registered users of the system 100 in the sense that they both have a wallet account (user profile) stored with the transaction server 110. As described above, each user profile contains information about each user, such as name, address, contact details, and financial details. The operation 200 commences at step 2-10 shown in FIG. 2.

At 2-10, the second user 135 operates the sender's device 140 to execute an EFT application that is specific to the EFT system 100. Whilst not described in detail, the EFT application presents a user interface to the second user 135 and facilitates communication between the sender's device 140 and the transaction server 110.

At 2-20, the sender's device 140, under the control of the EFT application prompts the second user 135 to select a premise 120. The premise 120 to be selected is the premise at which the second user 135 interacted with the first user 125, and to whom the second user 135 desires to transfer a sum of money (e.g. as a tip, or for any other reason). For example, in the case of the second user 135 being a customer at a restaurant where the second user 135 was served by the first user 125, the premise 120 to be selected is the restaurant. In the case where the second user 135 is a person who interacted with a street performer (for example, by watching the performance), the premise 120 to be selected is the geographical boundary specified by the street performer as being their “premise”. The selection of the premise 120 may be facilitated by determining the current location of the sender's device 140 and using the current location to determine (or propose) the premise 120. The selection of the premise 120 may also be made by requesting the second user 135 to specify a premise, for example by choosing from a list of premises or searching for a particular premise.

If it is desired to select a premise 120 by using the current location of the sender's device 140, the current location of the sender's device 140 is determined by using any geo location means available on the sender's device 140, such as GPS, WiFi, cellular signal, Bluetooth™, and the like. Once the current location of the sender's device 140 is determined, it is determined if the sender's device 140 is within the premise boundary 120A of a premise 120, and if so, which premise 120 the customer's device 140 is in. The determination of if, and which, premise boundary 120A the sender's device 140 is in may be conducted by way of the sender's device 140 determining if its current location is within that of the set of coordinates that define a premise boundary 120A, from a list of premise boundaries 120A obtained from the transaction server 110. Alternatively, if as previously described, a premise boundary 120A is defined by a wireless access point to which the sender's device 140 is connected (or in range of), the sender's device 140 determines which wireless access point it is connected to (or in range of) and refers to the list of premise boundaries 120A stored by the transaction server 100 to determine if the wireless access point which the sender's device 140 is connected to (or in range of) is associated with a premise 120. Other methods for determining if and which premise boundary the sender's device 140 is within, and hence which premise 120 the second user 135 interacted with the first user 125 at, may also be used.

Conversely, if it is desired to select a premise 120 by requesting the customer 135 to specify a premise, the sender's device 140 presents a list of selectable premises 120 to the second user 135 to select from (for example, based on distance from a current location of the sender's device 140) or prompts the second user 135 to search for a particular premise (for example, by keyword or other terms). Selecting a premise 120 in this manner allows the second user 135 to select a premise 120 that they may not currently be located at, for example a premise 120 that the second user 135 has already departed from.

At 2-30, once it is determined which premise 120 the customer 135 has selected, the sender's device 140 obtains from the transaction server 100 a list of first users 125 associated with the selected premise 120. Which users 125 are listed on this list may also depend on what, if any, merchant rules 170 stored on the transaction server 110 apply to the premise 120, the premise boundary 120A in which the sender's device 140 or recipient's device 130 is currently in, and/or the geographical coordinates that a merchant rule 170 is applicable to, and also may depend on what rules and conditions are specified by any such applicable merchant rules 170. For example, an applicable merchant rule 170 for a verified premise 120 may specify that only first users 125 (who have to already have been verified in order to be associated with the verified premise) who are also determined as being currently located at the premise 120 and further also verified by the premise controller 145 as currently working a shift at the premise 120, are available for the second user 135 to conduct a transfer of monies to. In this case, only first users 125 meeting such conditions would be included in the list, despite there possibly being other first users who are verified and hence associated with the verified premise 120 but who are either not currently located at the premise 120 and/or not currently working a shift at the verified premise 120. It should be understood that different and other combinations of such conditions may also be specified by applicable merchant rules 170. If no merchant policy 170 is applicable, then all first users 125 associated with the premise 120 would be listed, regardless of whether they are currently at the premise 120 or not, currently working a shift at the premise 120 or not, or regardless of any other condition.

The manner in which the transaction server 100 generates and keeps this list updated is described in greater detail below. The obtained list of first users 125 is then presented to the second user 135 by way of the EFT application. The list of first users 125 is presented to the second user 135 with minimal information about each first user 125 on the list. For example, the list may comprise only of a public profile picture chosen by each first user 125 to represent them, and/or an identifier, which could be the second user's real name, nickname, or other alias, or any other form of identifying indicia such as an alphanumeric identifier, colour, pattern, logo, insignia, etc.

At 2-40, the second user 135 selects a first user 125 from the list presented to the second user at 2-30. The second user 135 subsequently confirms that they desire to electronically transfer a sum of money (i.e. monies) to the selected first user 125 (e.g. a tip) and then enters in an amount to be transacted to the first user 125.

At 2-50, a confirmation screen confirming the first user 125 to whom the second user 135 desires to transfer the sum of money, and the amount to be transferred, is preferably displayed to the second user 135. Upon confirmation by the second user 135 that the information displayed on the confirmation screen is accurate, a transfer request is generated by the sender's device 140 and sent to the transaction server 100 over a network connection. The transfer request identifies at least the second user 135, the first user 125 to whom the second user 135 desires to transfer the sum of money, and the sum of money to be transferred. The second user 135 is identified in the transfer request by way of an ID associated with and uniquely identifying the second user's wallet account. Similarly, the first user 125 is identified in the transfer request by way of an ID associated with and uniquely identifying the first user's wallet account. The first user's ID is not visible to the second user 135. The second user's ID is also not visible to the first user 125, though this point is would be moot if the second user 135 is making the transfer of money anonymously.

For the avoidance of doubt, the first user 125 need not have any idea that the second user 135 intends to transfer a sum of money to them and does not need to provide any of their details to the second user 135 to enable the transfer. The second user 135 also does not gain access to any information about the first user 125 in the course of performing the transfer, other that the information mentioned above that the first user 125 explicitly chooses to make public (e.g. profile picture, name, alias, insignia, or other identifying indicia). The transaction performed by operation 200 is therefore unique in that it does not require either the first user 125 or the second user 135 to exchange information in order for the transaction to be processed successfully.

At 2-60, the transaction server 100 receives the transfer request from the sender's device 140 and processes the request. To process the request, the transaction server 100 identifies the wallet accounts belonging to the second user 135 using the IDs contained in the transfer request, confirms that the wallet account belonging to the second user 135 contains sufficient funds to effect the requested transfer (if necessary), identifies the wallet account of the first user 125, also using the IDs contained in the transfer request, and then performs the necessary backend electronic funds transfer procedures necessary to transfer the sum of money identified in the transfer request from one of the financial accounts stored in the second user's wallet account to one of the financial accounts stored in the first user's wallet account. For example, transaction server 100 may perform the necessary backend electronic fund transfer procedures to effect the transfer of the sum of money from a PayPal™ account of the second user 135 to a bank account of the first user 125. Such backend electronic fund transfer procedures are well known in the art, and the specifics of which are therefore not described here in detail.

The transfer of the sum of money from the second user 135 to the first user 125 may be made anonymously such that the identity of the second user 135 to the first user 125 is not revealed. However, the second user 135 may choose to reveal one or more pieces of information about themselves, if desired.

As is apparent from the above description, the EFT operation 200 allows the second user 135 to transfer a sum of money to the first user 125 with no information about the first user 125 being shared with the second user 135. Specifically, the transfer of money is effected without the second user 135 having to request any information from the first user 125, and with the first user 125 needing to only disclose to the second user 135 as little as a name (which may be an alias), a profile photo (which may not need to be an actual photo of the server), or some other identifying indicia (e.g. colour, pattern, logo, badge, insignia, etc.). Moreover, the transfer of money from the second user 135 to the first user 125 is initiated by the second user 135 rather than the second user 135 being prompted, encouraged, compelled, or otherwise engaged to make such a transfer. In this manner, the spirit, concept, and intent of voluntary transfer of money such as tipping is maintained.

Regardless of any merchant rules 170 applicable to a premise 120, the second user 135 has veto over any such rules which relate to how the money being transferred from the second user 135 is divided. For example, even if an applicable merchant rule 170 dictates that a percentage of any money transferred to one first user 125 is divided between all other first users 125 working at the premise, the second user 135 may override such a rule if they desire to transfer to a specific first user 125 100% of the amount being transferred.

With reference to FIG. 3, an operation 300 for verifying a user 125 as an employee at a verified premise 120 is described. The operation 300 commences at step 3-10.

At 3-10, the recipient's device 130 is operated by the first user 125 to search for a specific premise 120. For example, the recipient's device 130 obtains from the first user 125 one or more keywords, and sends a search query containing the keywords to the transaction server 110. Other methods for searching for a specific premise 120 may also be used, for example by browsing a list, using a current location, and the like.

At 3-20, once the first user 125 has searched for and identified the premise 120 that they wish to be verified with as a first user, the recipient's device 130 prompts the first user 125 to provide part of their user profile to the premise controller 145. The part of the user profile provided to the premise controller 145 should include information sufficient to identify the first user 125, for example the first user's first name, last name, phone number, and the like. The information may be provided directly from the recipient's device 130 to the premise controller's device 150, or provided to the premise controller's device 150 via the transaction server 110

At 3-30, the information provided in 3-20 by the first user 125 is received by the premise controller's device 150 and presented to the premise controller 145. The premise controller 145 then verifies or declines the request.

At 3-40, the transaction server 100 receives from the premise controller's device 150 the result of the premise controller's decision, namely whether or not the verification request from the first user 125 is accepted or declined. If the verification request from the first user 125 was accepted at 3-30, the transaction server 110 adds the first user to the list of verified workers associated with the premise 120.

Once a first user 125 is verified as a verified first user 125 of a verified premise 120, the first user 125 is able to appear in the list of first users visible to a second user 135 when the second user 135 is searching for or requesting for a list of first users 125 within the geographical boundary 120A or premise 120 (for example, the list presented to second users 135 at step 2-30), subject to any applicable merchant rules 170 managed by the transaction server 110 to the contrary.

In a preferred embodiment of the system 100, a premise controller 145 of a verified premise 120 is able to view the list of first users 125 currently visible to second customers 135, and add, remove, or block users 125 to/from this list.

As should be apparent from the above description of system 100, and operations 200 and 300, the present invention provides a system and method for facilitating electronic fund transfers from a first person (e.g. second user 135) to a second person (e.g. first user 125) with no information about the second person needed to be provided to the first person in order for the funds transfer to be completed.

Specifically, the system 100 of the present invention is able to effect an electronic fund transfer from a first person (e.g. a second user 135) to a second person (e.g. first user 125) with as little as a visual identifier or other identifying indicia corresponding to the first user 125 being made known to the second user 135 on the sender's device 140.

### Advantages

The EFT system according to the present invention allows for the transfer of money from a first party to a second party to be effected without the first party having to first obtain any information from the second party. Additionally, the EFT system according to the present invention allows for this transfer of money to occur with the first party needing no information about the second party or the second party ever being aware as to who the first party ever was. In allowing this, the EFT system of the present invention allows the first party to transfer money to the second party without being prompted, requested, or even expected to do so by the second party, and with the second party without having to divulge personal information about themselves.

### Variations

It will of course be realized that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. An electronic fund transfer system comprising:
a first device operated by one or more first users;
a second device operated by at least one second user, and
a server lo store user profiles of the one or more first users and the at least one second user, said profiles comprising account details and personal details of the one or more first users and the at least one second user,
wherein the one or more first users are associated with a premise, said premise being defined by a boundary of the premise comprising a physical perimeter, GPS coordinates, wireless access points, and/or a Bluetooth connection;
wherein the premise is a user-specified boundary comprising a delimited area in a park or a street corner, said user specified boundary being defined by a predetermined radius around the location of the premise by using GPS coordinates, wireless, and/or Bluetooth communication;
wherein a first user of the one or more first users is a verified user that is verified by a premise controller, said premise controller being a person that controls if an individual can be associated with the verified premise; and
wherein the server further stores associated information of the one or more first users and the premise;
wherein, in use, the second device is operable to obtain the associated information between the one or more first users and the premise, and a fund can be transferred by the at least one second user to the one or more first users without providing any of the account details or personal details of the one or more first users to the at least one second user.

2. An electronic fund transfer system as claimed in claim 1, wherein the associated information comprises a list of the one or more first users associated with the premise, and whether the one or more first users is a verified user associated with a verified premise.

3. An electronic fund transfer system as claimed in claim 2, wherein the second device is operable to select a first user from the list to transfer the fund.

4. An electronic fund transfer system as claimed in claim 1, wherein the premise is a fixed venue selected from the group consisting of a restaurant, a bar, a club, a shop, an office, a hall, a stadium, and combinations thereof, and wherein the boundary of the fixed venue is defined by a physical perimeter of the fixed venue.

5. An electronic fund transfer system as claimed in claim 1, wherein the premise is a mobile venue selected from the group consisting of a bus, a car, a taxi, a ship, a boat, a ferry, a train, a plane, a food cart, a drinks cart, and combinations thereof, and wherein the boundary of the mobile venue is defined by a predetermined radius around the location of the mobile venue by using GPS coordinates, wireless, and/or Bluetooth communication.

6. An electronic fund transfer system as claimed in claim 1, wherein the fund is selected from the group consisting of a merchant transaction from the at least one second user to the promise or the one or more first users, a voluntary transaction from the at least one second user to the premise or the one or more first users, and combinations thereof.

7. An electronic fund transfer system as claimed in claim 1, wherein the one or more first users is selected from the group consisting of a waiter, a bartender, a dancer, a cook, a chef, a musician, a busker, a shop owner, a stall owner, and combinations thereof.

8. An electronic fund transfer system as claimed in claim 1, wherein the at least one second user is a person either receiving, or that has received, a service at the premise, or a person having, or having bad, one or more interactions with the one or more first users at the premise.

9. An electronic fund transfer system as claimed in claim 1, wherein the server further stores a list of one or more premises and boundaries of the one or more premises.

10. An electronic fund transfer system as claimed in claim 1, wherein the server further stores one or more rules for interactions between the one or more first users and the one at least one second user, and wherein the one or more rules comprises determining whether the interaction occurs within the boundaries of the one or more premises.

11. An electronic fund transfer system as claimed in claim 1, wherein a first user of the one or more first users is a verified user associated with the one or more premises when verified by the premise controller, and wherein the verified user is in a list of the one or more first users associated with the one or more premises when the verified user is located within the boundaries of the one or more premises.

12. An electronic fund transfer system as claimed in claim 1, wherein the premise controller is a person who owns the premise and/or a person who is responsible for setting up and/or managing the premise.

13. An electronic fund transfer system as claimed in claim 1, wherein the system further comprises a third device operated by the premise controller; said third device interacting with the server to verify the premise and one or more of the first users.

14. An electronic fund transfer method using the system as claimed in claim 1, the method comprising:
selecting a premise from a list of one or more premises;
determining a location relative to boundaries of the one or more premises;
selecting one or more first users from a list of the one or more first users associated with the one or more premises;
determining verification of the one or more first users in a verified premise; and
transferring a fund to the selected one or more first users.

15.-21. (canceled)
